(19) United States
(12) Patent Application Publication
(10) Pub. No.: US 2005/0092330 A1
(43) Pub. Date: May 5, 2005

(54) Portable method and apparatus for converting a chair into a massage chair

(76) Inventor: David E. Henry, Grafton, MA (US)

Correspondence Address: EVELYN M. MARSHALL, ESQUIRE, 679 PLEASANT STREET, PAXTON, MA, 01612, US

(21) Appl. No.: 10/980,016

(22) Filed: Nov. 3, 2004

Related U.S. Application Data
(60) Provisional application No. 60/516,848, filed on Nov. 3, 2003.

(51) Int. Cl. A61H 1/00; A61G 15/00

(52) U.S. Cl. 128/845; 606/240

(57) ABSTRACT

The present invention achieves an effective way of converting any armless chair into a massage chair by attaching an H-shaped base portion to the exterior back of any armless curved or straight-back chair, said H-shaped base portion comprising an adjustable head support and adjustable arm supports, and provides proper sternum support.

### CROSS-REFERENCE TO RELATED APPLICATIONS

This application is copending with Provisional application Ser. No. 60/516,848, filed Nov. 3, 2003. I incorporate said provisional application by reference as fully set forth.

### STATEMENT REGARDING FEDERALLY SPONSORED RESEARCH AND DEVELOPMENT

This invention has been created without the sponsorship or funding of any federally sponsored research or development program.

### REFERENCE TO A “MICROFICHE APPENDIX”

Not Applicable

### BACKGROUND OF THE INVENTION

1. Field of the Invention

The present invention relates generally to massage apparatuses, and more specifically to a portable method and apparatus for converting a chair into a massage chair.

2. Prior Art

Massage apparatuses have been developed to aid in the performance of massage therapy. Such apparatuses include, inter alia, massage tables, massage mats and massage chairs. Furthermore said tables, chairs and mats may be designed to be stationary, portable, or both. The demand for portable massage apparatuses has grown over the years. In response to said demand there have been numerous designs for portable massage tables and chairs. Said portable massage tables and chairs tend to be bulky and cumbersome, to move and setup. There has also been a portable apparatus that converts an armless swivel chair into a massage chair, i.e., U.S. patent application No. US 2002/0096929 A1 filed by Showerman. However, to date there has not been a portable method and apparatus for converting an armless chair into a massage chair that is effective, simple in design, easy to use, which gives proper sternum support, provides patient-independent arm support and is adaptable to any armless chair.

The Showerman application, referenced above, discloses a portable massage chair converter comprised of a base portion, a headrest portion and a pair of forearm supports designed to be attached to the interior side of the back support of a flexible, D-back (lumbar support), swivel, central bearing, chair, as shown in FIGS. 1 and 2 of said Showerman application. Although said Showerman application states the portable massage chair converter “will convert a standard armless chair” into a massage chair, said portable massage chair converter is not designed to be used with most standard armless chairs, particularly since the arm supports must pass though an opening in the rear of the chair in order for the forearm supports to rest properly on the legs of the patient, and since most straight-back chairs have bilateral upright members passing through said opening, it will be obvious to one of ordinary skill in the art that said Showerman portable massage chair converter cannot be used with most standard armless chairs. Furthermore, it will be understood by one of ordinary skill in the art that when the said Showerman portable massage chair converter is attached to the aforementioned swivel chair, said chair will swivel and possibly tip during massage or would be useless if said chair is equipped with wheels, which is the way the disclosed style of chair is standardly made. And still further, Showerman's base portion must be attached to the interior back of said swivel chair since the attachment means and said forearm supports will not function properly from the exterior of said swivel chair, as will be readily apparent to one of ordinary skill in the art. Additionally, due to the interior connection of said Showerman portable massage chair converter and the exposed hardware used to adjust the head height and angle, said massage chair converter does not provide proper sternum support, as will be apparent to one of ordinary skill in the art by viewing FIG. 1 of said Showerman application. Also, said Showerman portable massage chair converter does not disclose patient-independent arm supports, which are more desirable during massage.

There is therefore a need in the art for a portable method and apparatus for converting a chair into a massage chair that is light-weight, effective, simple in design, easy to use, gives proper sternum and head support, provides patient-independent arm support and is adaptable to any armless chair.

It is therefore a principal object of the present invention to provide a portable method and apparatus for converting a chair into a massage chair that is adaptable to any armless chair.

A further object of the present invention is to provide a portable method and apparatus for converting a chair into a massage chair that provides patient-independent arm support.

A further object of the present invention is to provide a portable method and apparatus for converting a chair into a massage chair that provides sternum and head support.

A further object of the present invention is to provide a portable method and apparatus for converting a chair into a massage chair that is lightweight.

A further object of the present invention is to provide a portable massage chair converter that is effective, simple in design and easy to use. With these and other objects in view, as will be apparent to those skilled in the art, the invention resides in the combination of parts set forth in the specification and covered by the claims appended hereto.

### BRIEF SUMMARY OF THE INVENTION

A novel approach to converting any armless chair into a massage chair has now been discovered, thus providing the user with a portable method and apparatus for converting a chair into a massage chair that is light-weight, effective, simple in design, and easy to use, gives proper sternum and head support, provides patient-independent arm support and is adaptable to any armless chair. The present invention achieves an effective way of converting any armless chair into a massage chair by attaching an H-shaped base portion to the exterior back of any armless curved or straight-back chair, said H-shaped base portion comprising an adjustable head support and adjustable arm supports, and provides proper sternum support. The primary advantage of using the present invention is that the user will be able to easily adapt the present light-weight invention to any armless chair on site, and thus the present invention will make it easier for the user to administer massage on-site, i.e., at an office, mall or home, while providing proper sternum, head and arm support. The present invention will be hereinafter referred to as the Chair Massage Bracket.

These and other objects will be apparent to those skilled in the art, along with advantages and features of the invention disclosed herein, will be made more apparent from the description, drawings and claims that follow.

### BRIEF DESCRIPTION OF THE DRAWINGS

The foregoing and other objects, features and advantages of the present invention, as well as the invention itself, will be more fully understood from the following description of preferred embodiments, when read together with the accompanying drawings, in which:

FIG. 1 is a rear perspective view of an embodiment of the present invention attached to a straight-backed chair.

FIG. 2 is a top left perspective view of an embodiment of the armrest of the present invention.

FIG. 3 is a top right perspective view of an embodiment of the chair pad of the present invention.

### NUMBERING OF THE DRAWINGS

2. Chair Massage Bracket
4. Base Portion
6. Face Cradle Support
8. Armrest Support
10. Armrest Support Connecting Means
12. Face Cradle Support Connecting Means
14′. Face Cradle Connecting Means
14″. Face Cradle Connecting Means
16. Face Cradle
18. Armrest
20. Chair Pad
22. Chair Massage Bracket Support Means
24. Chair Massage Bracket Connecting Means
26. Face Cradle Support Adjustment Means
28. Base Portion Front
30. Base Portion Rear
32. Base Portion Horizontal Segment
34. Base Portion Vertical Segment
36. Chair Massage Bracket Support Connecting Means

### DETAILED DESCRIPTION OF THE INVENTION

In the broadest aspects, the present invention provides the skilled artisan with the analytical tools and technical know-how sufficient to make and use the disclosed invention. The present invention provides the user with a portable method and apparatus for converting an armless chair into a massage chair that is lightweight, effective, simple in design, and easy to use, gives proper sternum and head support, provides patient-independent arm support and is adaptable to any armless curved or straight-back chair.

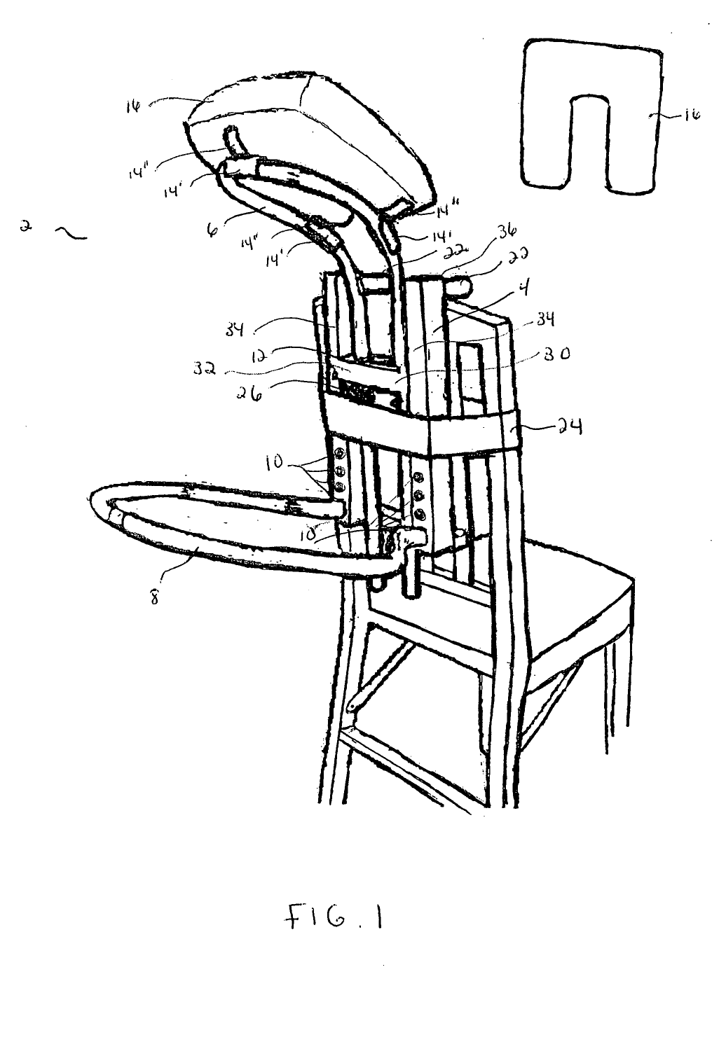

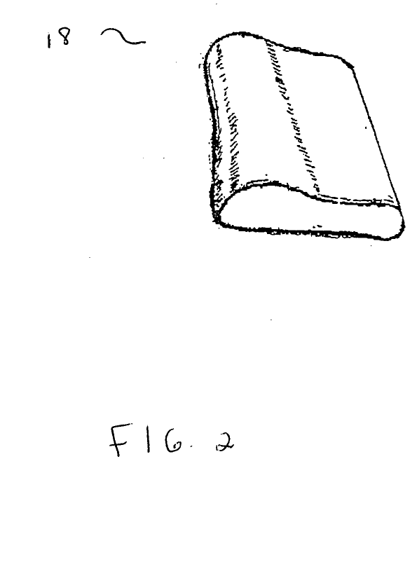

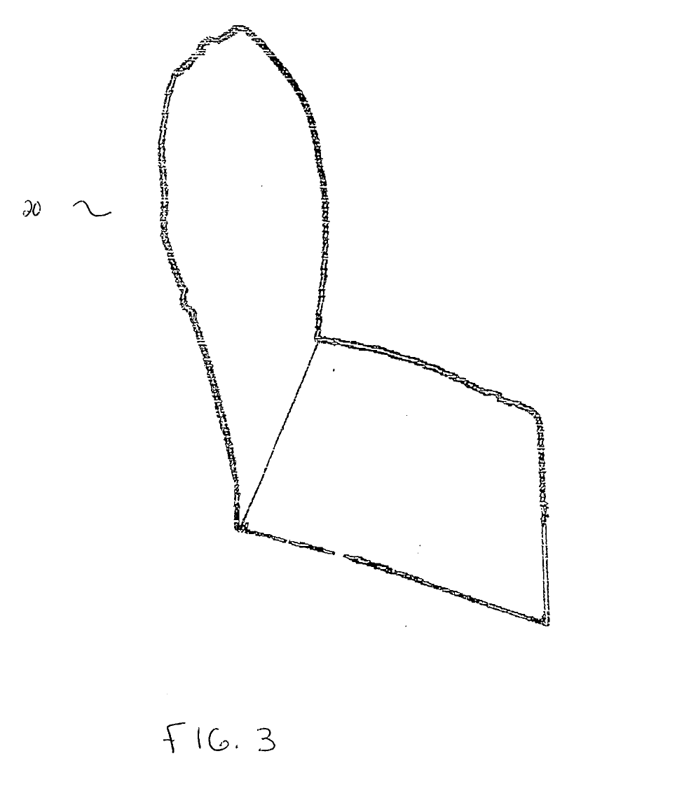

Referring to FIGS. 1 through 3, where like elements are indicated by like numerals, an embodiment of the present invention, in its most basic form, is generally indicated by the reference numeral 2, and comprises a base portion, generally indicated by reference numeral 4, a face cradle support, generally indicated by reference numeral 6, and a armrest support, generally indicated by reference numeral 8. The chair massage bracket 2 is shown in functional form.

In further detail, in the preferred embodiment, said base portion 4 is H-shaped and comprises a base portion front 28 (not shown), a base portion rear 30, a base portion horizontal segment 32, two base portion vertical segments 34, chair massage bracket support means 22, chair massage bracket support connecting means 36, chair massage bracket connecting means 24, face cradle support connecting means 12, and armrest support connecting means 10. Said base portion 4 is H-shaped with said base portion horizontal segment 32 intersecting said base portion vertical segments 34 approximately midway and as shown in FIG. 1. Said base portion 4 may be made up of several pieces or be one unit and is made out of a durable material such as wood or hard plastic. Other equivalent substances would also be suitable. Identification of equivalents is well within the skill of the ordinary practitioner and would require no more than routine experimentation. Said base portion 4 may have more than one base portion horizontal segment 32 and said base portion vertical segments 34 may be more or less than two in number, or may be a solid shaped unit, as would be obvious to one of ordinary skill in the art. Said chair massage bracket support means 22, each connected at the top of said base portion vertical segments 34, may be made out of the same material as said base portion 4, are shaped to rest on the top of said armless chair, are connected to said base portion front 28 (not shown) at the at the top of base portion vertical segments 34 by said chair massage bracket support connecting means 36, as are shown in FIG. 1. Said chair massage bracket support connecting means 36 typically consists of holes or openings in the top front of said base portion vertical segments 34 and said chair massage bracket support means are inserted into said holes or openings, all as are known to one of ordinary skill in the art. Said chair massage bracket connecting means 24 generally consists of a VELCRO® strap which secures said base portion rear 30 of chair massage bracket 2 to the back of said armless chair approximately at said base portion horizontal segment 32, as is shown in FIG. 1. Other equivalent connecting means would also be suitable, such as sandwich bolting or NYLON® cord. Identification of equivalents is well within the skill of the ordinary practitioner and would require no more than routine experimentation. Said face cradle support connecting means 12 typically consist of holes or openings horizontally through said base portion horizontal segment 32, as shown in FIG. 1. Other equivalent connecting means would also be suitable. Identification of equivalents is well within the skill of the ordinary practitioner and would require no more than routine experimentation. Said armrest support connecting means 10 typically consist of a series of holes or openings in the lower rear of said base portion vertical segments 34, such that there are several armrest support connecting means to allow for height differences for patient comfort, as shown in FIG. 1. Other equivalent connecting means would also be suitable. Identification of equivalents is well within the skill of the ordinary practitioner and would require no more than routine experimentation.

In further detail, said face cradle support 6 is generally comprised of plastic tubing where both ends are inserted into said face cradle support connecting means 12 resulting in a U-shaped portion extending from the top of said base portion 4, as shown in FIG. 1. Said face cradle support 6 is adjustable through said face cradle support connecting means 12 to adjust to the height of the patient. Said face cradle support connecting means 12 includes a face cradle support adjustment means 26, which essentially consists of a pipe clamp style stop device on the lower side of said base portion horizontal segment 32 where said ends of said tubing pass through said base portion horizontal segment 32 and said face cradle support adjustment means 26. Other equivalent adjustment means would also be suitable. Identification of equivalents is well within the skill of the ordinary practitioner and would require no more than routine experimentation. Said face cradle support adjustment means 26 allows the user to easily adjust and secure said face cradle support 6. Face cradle connecting means 14′ are attached to said face cradle support 6, by means known by one of ordinary skill in the art. Face cradle connecting means 14″ are attached to face cradle 16, by means known by one of ordinary skill in the art. Face cradle 16 is attached to face cradle support 6 by face cradle connecting means 14′ and 14″. Said face cradle connecting means 14′ and 14″ are VELCRO® in the preferred embodiment. Other equivalent connecting means would also be suitable. Identification of equivalents is well within the skill of the ordinary practitioner and would require no more than routine experimentation.

In further detail, said armrest support 8 is generally comprised of plastic tubing where both ends are inserted into any one of a series of said armrest support connecting means 10 on each of said base portion vertical segments 34, at the same level, resulting in an oval shaped support extending from the lower base portion rear 30 of said base portion 4. Said armrest support 8 is adjustable by selecting any of said series of said armrest connecting means 10, as shown in FIG. 1. Armrest 18 is supported by armrest support 8. Other equivalent supporting/connecting means would also be suitable. Identification of equivalents is well within the skill of the ordinary practitioner and would require no more than routine experimentation.

In practice the system works as follows: The user sets up the chair massage bracket 2 by connecting the base portion 4 to the exterior back of a curved or straight backed armless chair. The patient sits in the chair facing backwards. The user adjusts the height of the face cradle support 6 to the optimum height for the patient by using said face cradle support adjustment means 26. The user adjusts the height of the armrest support 8 to the optimum height for the patient by selectively inserting said armrest support 8 into the desired armrest support connecting means 10. The user attaches the face cradle 16 to the face cradle support 6 as described above. The user attaches the armrest 18 to the armrest support 8 as described above. The user inserts the chair pad 20 between the front of the patient and the back of the chair for proper sternum support. The patient rests his face on the face cradle 16. The patient rests his torso on the chair pad 20. The patient rests his arms on the armrest support 8. The user gives the patient a massage.

The invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims rather than by the foregoing description, and all changes which come within the meaning and range of equivalency of the claims are therefore intended to be embraced herein.

1. An apparatus for facilitating seated massage utilizing any armless curved or straight back chair comprising:
a. A base portion, wherein said base portion is attached to the exterior back of said armless chair via a chair massage bracket connecting means and a chair massage bracket support means; and
b. A face cradle support, wherein said face cradle support is connected to said base portion via face cradle support connecting means.

2. The apparatus of claim 1, further comprising a face cradle, wherein said face cradle is attached to said face cradle support via face cradle connecting means.

3. The apparatus of claim 2, further comprising a face cradle support adjustment means, wherein said face cradle adjustment means is incorporated in said base portion.

4. The apparatus of claim 1, wherein said base portion is “H” shaped.

5. The apparatus of claim 1, further comprising an armrest support, wherein said armrest support is connected to said base portion via armrest support connecting means.

6. The apparatus of claim 5, further comprising an armrest, wherein said armrest is supported by said armrest support.

7. The apparatus of claim 5, further comprising armrest adjustment means, wherein said armrest adjustment means is connected to said base portion.

8. The apparatus of claim 1, further comprising a chair pad, wherein said chair pad is placed between a client and said chair and said apparatus.

9. An apparatus for facilitating seated massage utilizing any armless curved or straight back chair comprising:
a. A base portion, wherein said base portion is attached to the exterior back of said armless chair via a chair massage bracket connecting means and a chair massage bracket support means;
b. A face cradle support, wherein said face cradle support is connected to said base portion via face cradle support connecting means; and
c. An armrest support, wherein said armrest support is independently supported and is connected to said base portion via armrest support connecting means.

10. The apparatus of claim 9, further comprising a face cradle, wherein said face cradle is attached to said face cradle support via face cradle connecting means.

11. The apparatus of claim 10, further comprising a face cradle support adjustment means, wherein said face cradle adjustment means is incorporated in said base portion.

12. The apparatus of claim 11, further comprising an armrest support, wherein said armrest support is connected to said base portion via armrest support connecting means.

13. The apparatus of claim 12, further comprising an armrest, wherein said armrest is supported by said armrest support.

14. The apparatus of claim 13, further comprising armrest adjustment means, wherein said armrest adjustment means is connected to said base portion.

15. The apparatus of claim 14, further comprising a chair pad, wherein said chair pad is placed between a client and said chair and said apparatus.

16. The apparatus of claim 15, wherein said base portion is “H” shaped.

17. A method for converting an armless curved or straight back chair into a massage chair, comprising the steps of:
a. Attaching the chair massage bracket to the exterior back of a curved or straight backed armless chair, wherein said chair massage bracket is attached via chair massage bracket support means and chair massage bracket connecting means;
b. Adjusting the height of the face cradle support to the optimum height for the patient by utilizing the face cradle support adjustment means;
c. Adjusting the height of the armrest support to the optimum height for the patient by selectively inserting the arm rest support into the desired armrest support connecting means;
d. Attaching the face cradle to the face cradle support;
e. Attaching the armrest to the armrest support;
f. Placing the chair pad on the said chair.
